(19) United States
(12) Patent Application Publication
(10) Pub. No.: US 2017/0192338 A1
(43) Pub. Date: Jul. 6, 2017

(54) GIMBAL AND AIRCRAFT

(71) Applicant: ZEROTECH (Chongqing) Intelligence Technology Co., Ltd., Chongqing (CN)

(72) Inventors: HONGTAO SUN, Beijing (CN); XIANWEI REN, Beijing (CN); CHAO WANG, Beijing (CN); GENGPENG LIU, Beijing (CN)

(21) Appl. No.: 15/398,212

(22) Filed: Jan. 4, 2017

(30) Foreign Application Priority Data
Jan. 5, 2016 (CN) 201610006939.8
Jan. 5, 2016 (CN) 201620010329.0

(51) Int. Cl. G03B 15/00; F16M 11/12; F16M 11/18; B64D 47/08

(52) U.S. Cl. CPC G03B 15/006; B64D 47/08; F16M 11/121; F16M 11/18; B64C 39/024

(57) ABSTRACT

The present disclosure relates to the technical field of aircrafts and in particular to a gimbal and an aircraft having the same. The gimbal comprises a yaw axis motor, a rolling axis motor, a pitching axis motor and a control box. The yaw axis motor is connected with the rolling axis motor via a first connecting shaft arm, the rolling axis motor is connected with the pitching axis motor via a second connecting shaft arm, and the control box is located below the yaw axis motor or on the aircraft. In an embodiment, by disposing the control box below the yaw axis motor, the overall mass of a structure below the yaw axis motor can be increased, and the moment of inertia in the yaw axis increases correspondingly, thereby solving the problem of failure to achieve stability augmentation due to a small moment of inertia in the yaw axis.

### CROSS-REFERENCE TO RELATED APPLICATIONS

This application claims priority to Chinese Patent Application No. 201610006939.8, filed with the State Intellectual Property Office of China on Jan. 5, 2016, and entitled “Gimbal,” the entire contents of which are hereby incorporated by reference. This application also claims priority to Chinese Patent Application No. 201620010329.0, filed with the State Intellectual Property Office of China on Jan. 5, 2016, and entitled “Control Box,” the entire contents of which are hereby incorporated by reference.

### FIELD

The present disclosure relates to the technical field of aircrafts, and in particular to a gimbal for carrying an imaging device on an aircraft, and to an aircraft having the same.

### BACKGROUND

Generally, an airborne gimbal of an unmanned aircraft refers to a supporting platform on which an imaging device is mounted, where the imaging device may be a video camera or a camera. The purpose of photographing an object with a lens of the imaging device is realized by adjustment of the gimbal. On the gimbal, a yaw axis motor adopts mostly negative mounting, whereas a rolling axis motor and a pitching axis motor adopt positive mounting. The so-called “negative mounting” means that a stator portion of the motor is connected with a rotatable shaft arm, and a rotor portion of the motor is connected with a fixed shaft arm. The positive mounting is in the contrary situation to the negative mounting.

With the development of technology, gimbals are gradually developed towards small size, light weight and low cost. However, when the gimbal rotates around a yaw axis, the purpose of making the aircraft and the gimbal as a whole stabilized during a flight would most likely not be achieved as a result of a small moment of inertia in the yaw axis. In order to solve this problem, a counterweight device is mounted on the gimbal in the prior art. However, such technical solution provides additional parts to the gimbal, which increases the overall weight of the gimbal, and therefore it is unable to achieve the purpose of reducing the overall weight of the gimbal.

### SUMMARY

One object of embodiments of the present disclosure is to provide a gimbal, which can solve the problem of failure to achieve stability augmentation as a result of a small moment of inertia in a yaw axis, without increasing the overall weight of the gimbal.

Another object of the embodiments of the present disclosure is to provide an aircraft.

To this end, the embodiments of the present disclosure employ technical solutions as follows.

A gimbal includes a yaw axis motor, a rolling axis motor, a pitching axis motor and a control box. The yaw axis motor is connected with the rolling axis motor via a first connecting shaft arm, and the rolling axis motor is connected with the pitching axis motor via a second connecting shaft arm. The control box is located below the yaw axis motor.

Preferably, the control box is connected with the yaw axis motor, the first connecting shaft arm, the second connecting shaft arm, the rolling axis motor, or the pitching axis motor.

Preferably, the rolling axis motor is located below the yaw axis motor, the control box is located behind the rolling axis motor, and the control box and the rolling axis motor are fixedly disposed on both sides of the first connecting shaft arm, respectively.

Preferably, the control box is located on one side of the first connecting shaft arm, and the rolling axis motor, the second connecting shaft arm and the pitching axis motor are located on the other side of the first connecting shaft arm opposite to the control box.

Preferably, the first connecting shaft arm includes a first connecting section and a second connecting section disposed perpendicular to each other, the first connecting section is provided thereon with a first receiving seat protruding, the second connecting section is provided thereon with a second receiving seat protruding, the yaw axis motor is received in the first receiving seat, and the rolling axis motor is received in the second receiving seat.

Preferably, the second connecting shaft arm includes a third connecting section and a fourth connecting section disposed perpendicular to each other, the third connecting section is provided thereon with a third receiving seat protruding, the fourth connecting section is provided thereon with a fourth receiving seat protruding, the rolling axis motor is received in the third receiving seat, and the pitching axis motor is received in the fourth receiving seat.

Preferably, the rolling axis motor is located below the yaw axis motor, the control box is located in front of the rolling axis motor, and the control box is fixed to the rolling axis motor or the second connecting shaft arm.

Preferably, the pitching axis motor is located below the yaw axis motor, and the control box is fixedly disposed on one side of the pitching axis motor.

Preferably, the control box is fixedly disposed on the yaw axis motor.

Preferably, the control box is of a rectangular structure.

Preferably, the control box includes a first housing and a second housing connected with each other and disposed opposite to each other, a control assembly is mounted within the first housing and the second housing, the control assembly includes one or more control boards connected to each of the first housing and the second housing, and the one or more control boards are provided thereon with drive circuits and control circuits.

Preferably, the number of the control boards is not less than two, and the control assembly further includes a flexible connecting plate by which adjacent two of the control boards are electrically connected with each other.

Preferably, each of the control boards is provided thereon with a plurality of inserts, and is connected with the first housing and the second housing by the inserts.

Preferably, the number of the control boards is not less than two, the control boards are laminated in row in a layered manner, and the control boards located at two end sides are provided with connection terminals, respectively, with the connection terminals disposed to partially pass through the first housing and the second housing.

Preferably, the number of the control boards is not less than two, with a part of the control boards provided thereon with the control circuits, and the other part of the control boards provided thereon with the drive circuits connected with the control circuits.

Preferably, the first housing and the second housing are hollow, and the first housing and the second housing each are provided thereon with a plurality of mounting grooves, and the inserts pass through the mounting grooves to make the control boards connected with each of the first housing and the second housing.

Preferably, a first open groove is provided in a side wall of the first housing, a second open groove opposite to the first open groove is provided in a side wall of the second housing, and the connection terminal partially passes through the first open groove and the second open groove and is partially located outside the first housing and the second housing.

Preferably, each of the first housing and the second housing is provided with a mounting hole, the mounting hole in the first housing is disposed at a position opposite to that of the mounting hole in the second housing, and a fastener passes through the mounting holes of both the first housing and the second housing to make the first housing and the second housing connected with each other.

Preferably, one end of the first housing is provided with a connecting plate extending therefrom, and the connecting plate is provided thereon with a connecting hole.

Preferably, a clasper is provided on a side wall of the first housing, with the clasper located below the connecting plate.

An aircraft includes a gimbal which is any one of the gimbals described above.

In the embodiments of the present disclosure, by disposing the control box below the yaw axis motor, the overall mass of a structure below the yaw axis motor can be increased, and a vertical distance from the center of mass of the structure below the yaw axis motor to the yaw axis can also be increased; and once the weight of the structure below the yaw axis motor and the distance from the center of mass of the structure below the yaw axis motor to the yaw axis are increased, the moment of inertia in the yaw axis increases accordingly, thereby solving the problem of failure to achieve stability augmentation as a result of a small moment of inertia in the yaw axis. Meanwhile, the control box, being an important component of the gimbal, makes the overall mass of the structure below the yaw axis motor increased while avoiding an increase in the overall weight of the gimbal, thereby further ensuring that the gimbal has a light overall weight.

### BRIEF DESCRIPTION OF THE DRAWINGS

The above and other objects, features and advantages of the present disclosure will become more apparent, from the following detailed description of exemplary embodiments of the present disclosure given in conjunction with the drawings. Like reference numerals generally designate like components throughout the exemplary embodiments of the present disclosure.

FIG. 1 is a schematic structural view of a gimbal provided by an embodiment of the present disclosure;

FIG. 2 is a front view of a gimbal provided by an embodiment of the present disclosure;

FIG. 3 is a schematic assembled view of a control box provided by an embodiment of the present disclosure;

FIG. 4 is a schematic exploded view of the control box shown in FIG. 3;

FIG. 5 is a schematic structural view of a first housing of the control box shown in FIG. 3;

FIG. 6 is a schematic structural view of a second housing of the control box shown in FIG. 3; and

FIG. 7 is a schematic structural view of a control assembly of the control box shown in FIG. 3.

The following numeric references are used throughout the figures:

1—yaw axis motor;

11—yaw axis motor stator;

2—rolling axis motor;

21—rolling axis motor rotor;

3—pitching axis motor;

31—pitching axis motor rotor;

4—control box;

41—first housing;

42—second housing;

43—control assembly;

44—mounting groove;

45—mounting hole;

46—fastener;

47—connection terminal;

48—first open groove;

49—second open groove;

411—connecting plate;

412—connecting hole;

413—clasper;

414—first accommodating groove;

415—first side wall;

416—second side wall;

417—upper surface;

418—first mounting groove;

419—first mounting hole;

421—second accommodating groove;

422—third side wall;

423—fourth side wall;

424—lower surface;

425—second mounting groove;

42—second mounting hole;

431—control board;

432—flexible connecting plate;

4311—insert;

4312—drive circuit;

4313—control circuit;

5—first connecting shaft arm;

51—first connecting section;

52—second connecting section;

53—first receiving seat;

54—second receiving seat;

6—second connecting shaft arm;

61—third connecting section;

62—fourth connecting section;

63—third receiving seat;

64—fourth receiving seat;

7—imaging device; and

8—gimbal.

### DETAILED DESCRIPTION

In order to enable those skilled in the art to better understand technical solutions of the present disclosure, the technical solutions of the present disclosure will be further illustrated by way of specific embodiments in conjunction with the drawings.

In the description and illustration of the present disclosure, it is to be understood that the orientation or positional relationships indicated by terms, such as “upper”, “lower”, “front” and “rear”, are based on the orientation or positional relationships shown in the drawings, and these terms are intended only to facilitate the description of the present disclosure and to simplify the description, and not to indicate or imply that the referred devices or elements must be in a particular orientation, or constructed and operated in a particular orientation, and therefore, they should not be construed as limiting the present disclosure.

### Exemplary Embodiments

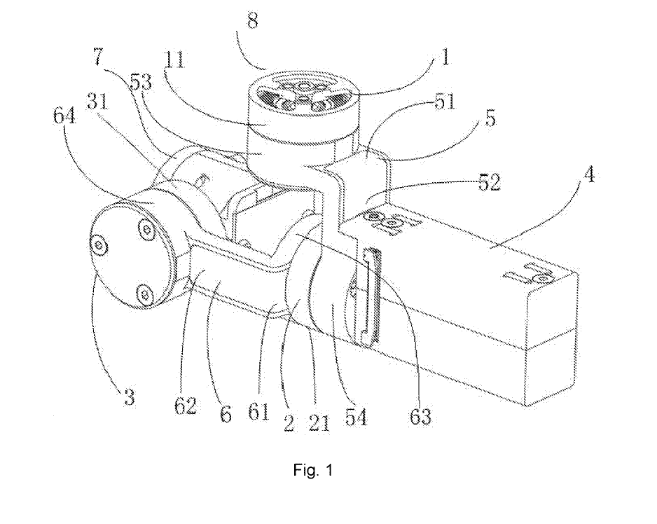

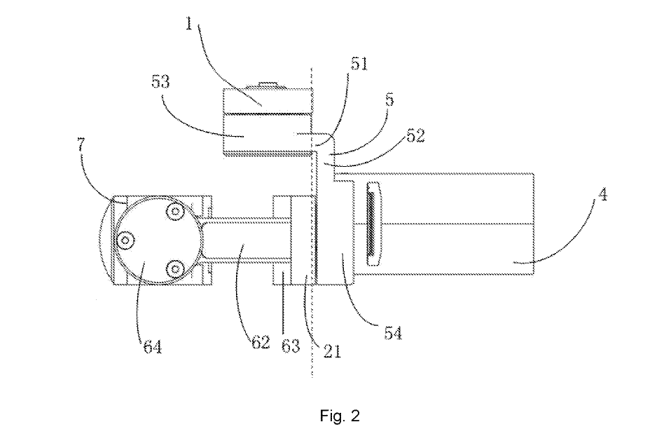

Referring to FIG. 1 in combination with FIG. 2, the present embodiment provides a gimbal 8. The gimbal 8 includes a yaw axis motor 1, a rolling axis motor 2, a pitching axis motor 3, a control box 4, a first connecting shaft arm 5 and a second connecting shaft arm 6.

Still referring to FIG. 1 in combination with FIG. 2, in the present embodiment, the first connecting shaft arm 5 includes a first connecting section 51 and a second connecting section 52 disposed substantially perpendicular to each other so that the first connecting shaft arm 5 is substantially L-shaped. One end of the first connecting section 51, which is remote from the second connecting section 52, is provided with a first receiving seat 53 protruding and having a circular shape. One end of the second connecting section 52, which is remote from the first connecting section 51, is provided with a second receiving seat 54 protruding and having a circular shape. Here, the first receiving seat 53 has an axis substantially parallel to the second connecting section 52, and the second receiving seat 54 has an axis substantially parallel to the first connecting section 51. The second connecting shaft arm 6 includes a third connecting section 61 and a fourth connecting section 62 disposed substantially perpendicular to each other so that the second connecting shaft arm 6 is substantially L-shaped. One end of the third connecting section 61, which is remote from the fourth connecting section 62, is provided with a third receiving seat 63 protruding and having a circular shape. One end of the fourth connecting section 62, which is remote from the third connecting section 61, is provided with a fourth receiving seat 64 protruding and having a circular shape. Here, the third receiving seat 63 is coaxial with the second receiving seat 54, and the fourth receiving seat 64 has an axis substantially parallel to the third connecting section 61.

Still referring to FIG. 1 and FIG. 2, in the present embodiment, the yaw axis motor 1 is received in the first receiving seat 53. The yaw axis motor 1 adopts negative mounting, that is, a yaw axis motor stator 11 of the yaw axis motor 1 is fixedly connected with the first receiving seat 53, and a yaw axis motor rotor (not shown) of the yaw axis motor 1 is connected with an aircraft (not shown) by a connection platform (not shown). The rolling axis motor 2 is received in the second receiving seat 54. The rolling axis motor 2 adopts positive mounting, that is, a rolling axis motor stator (not shown) of the rolling axis motor 2 is fixedly connected with the second receiving seat 54, and a rolling axis motor rotor 21 of the rolling axis motor 2 is fixedly connected with the third receiving seat 63. The pitching axis motor 3 is received in the fourth receiving seat 64. The pitching axis motor 3 adopts positive mounting, that is, a pitching axis motor stator (not shown) of the pitching axis motor 3 is fixedly connected with the fourth receiving seat 64.

Still referring to FIG. 1 in combination with FIG. 2, in the present embodiment, the control box 4 has a rectangular shape as a whole, and is connected to one end of the second connecting section 52 that is remote from the first connecting section 51. As can be seen from FIG. 1, the control box 4 is located below the yaw axis motor 1. As can also be seen from FIG. 1, the control box 4 is located behind the rolling axis motor 2, that is, the control box 4 is located on a side of the rolling axis motor 2 that is near the rolling axis motor stator (not shown). The control box 4 is located on one side of the second connecting section 52, and the rolling axis motor 2, the second connecting shaft arm 6 and the pitching axis motor 3 are located on the other side of the second connecting section 52 opposite to the control box 4. The length direction of the control box 4 is parallel to the length direction of the fourth connecting section 62, so that the structure of the gimbal 8 that is located below the yaw axis motor 1 has a substantially elongated shape.

When the gimbal 8 shown in FIG. 1 and FIG. 2 operates, a pitching axis motor rotor 31 of the pitching axis motor 3 is connected with the imaging device 7. The yaw axis motor 1 drives the rolling axis motor 2, the pitching axis motor 3, the control box 4, the first connecting shaft arm 5 and the second connecting shaft arm 6 to rotate about the yaw axis; the rolling axis motor 2 drives the pitching axis motor 3 and the second connecting shaft arm 6 to rotate about the rolling axis; and the pitching axis motor 3 drives the imaging device 7 to rotate about the pitching axis. In this way, the imaging device 7 is able to photograph at multiple different angles. During operation of the yaw axis motor 1, as being disposed below the yaw axis motor 1, the control box 4 makes the mass of the structure of the gimbal 8 that is located below the yaw axis motor 1 increased, accordingly, the moment of inertia of the structure of the gimbal 8 that is located below the yaw axis motor 1, generated when such structure rotates about the yaw axis, is increased, thereby improving the stability augmentation effect when the structure below the yaw axis motor 1 rotates around the yaw axis. The control box 4 is configured to control operations of the yaw axis motor 1, the rolling axis motor 2 and the pitching axis motor 3, and is an important component of the gimbal 8. By utilizing the mass of the control box 4, the gimbal 8 provided in the present embodiment improves the stability augmentation effect when the structure below the yaw axis motor 1 rotates about the yaw axis, without additional arrangement or configuration, thereby improving the stability augmentation effect without increasing the overall weight of the gimbal 8.

In the present embodiment, the control box 4 has a rectangular shape as a whole, so that the structure of the gimbal 8 that is located below the yaw axis motor 1 has a substantially elongated shape. Such a structure makes a vertical distance from the center of mass of the structure below the yaw axis motor 1 to the yaw axis increased, which enables the moment of inertia of the structure below the yaw axis motor 1 to be further increased, thereby achieving an effect of rapid stability augmentation. It will be appreciated that, in other specific embodiments, the control box 4 may have various shapes and is not limited to the rectangular shape.

As a connection line for connecting the motor to the control box is led out from the motor stator, if the control box 4 is mounted above the gimbal, the connection lines for connecting the yaw axis motor 1, the rolling axis motor 2 and the pitching axis motor 3 to the control box 4 each need to be wound before they are connected to the control box 4, so as to ensure the normal operation of the gimbal. However, it is cumbersome to wind the connection lines during a mounting process. In contrast, the above-mentioned problem can be solved if the control box 4 is mounted behind the rolling axis motor 2, in this case, the connection line for connecting the rolling axis motor 2 to the control box 4 and the connection line for connecting the yaw axis motor 1 to the control box 4 can be connected directly to the control box 4 without being wound, but the connection line for connecting the pitching axis motor 3 to the control box 4 needs to be wound at the rolling axis motor 2 before being connected to the control box 4. Preferably, the connection line for connecting the pitching axis motor 3 to the control box 4 is wound so as to pass through the second connecting shaft arm 6 before being connected to the control box 4, and the connection line for connecting the yaw axis motor 1 to the control box 4 is wound so as to pass through the first connecting shaft arm 5 before being connected to the control box 4.

It is to be noted that, in the present embodiment, the control box 4 is connected with the first connecting shaft arm 5. It will be appreciated that, in other specific embodiments, the control box 4 may also be connected with the yaw axis motor 1, the second connecting shaft arm 6, the rolling axis motor 2, or the pitching axis motor 3.

For example, the control box 4 may be located in front of the rolling axis motor 2, and the control box 4 may be fixed onto the rolling axis motor 2 or the second connecting shaft arm 6. Being in front of the rolling axis motor 2 specifically refers to being in front of the rolling axis motor rotor 21. In addition, the length of the first connecting shaft arm 5 should be extended, to fit the above-mentioned structural arrangement.

For yet another example, the control box 4 may also be fixedly disposed behind the pitching axis motor 3. That is, the imaging device 7 and the control box 4 are located in front of and behind the pitching axis motor 3, respectively, and the control box 4 does not rotate with the pitching axis motor 3 during a process that the pitching axis motor 3 drives the imaging device 7 to rotate. In addition, with this structure, the length of the first connecting shaft arm 5 should be extended, to prevent instability of the whole aircraft due to deviation of the center of mass caused by the change in weight.

For still another example, the control box 4 may also be located below the yaw axis motor 1, and the control box 4 may be fixedly disposed on the yaw axis motor 1. Specifically, the control box 4 is fixedly disposed on the yaw axis motor stator 11. Similarly, the length of the first connecting shaft arm 5 in this case needs to be extended accordingly.

At present, a conventional gimbal is provided with a driver and a controller for each motor, to achieve the purpose of controlling the movement of the motors and other functional components on the gimbal. However, such design is too complicated and has too many assembly components (for a three-axis gimbal, three drivers and three controllers require to be assembled), making the assembly process too cumbersome. In contrast, as can be seen from FIG. 1 and FIG. 2, the gimbal 8 provided by the present embodiment has only one control box 4. By integrating, onto a control board in the control box 4, drivers and controllers provided respectively for the individual motors of a prior gimbal, it is possible to reduce the complexity of providing the drivers and controllers respectively, reduce the assembly components, and simplify the assembly process. In addition, as for the gimbal 8 provided in the present embodiment, the operations of individual components of the gimbal 8 can be controlled with only one control box 4, which makes the control of the gimbal 8 more centralized. Moreover, the gimbal 8 provided by the present embodiment has a small size since a large integrated circuit board is divided into at least two control boards disposed in a layered manner, which is more suitable for small-sized gimbals.

To achieve the above object, the control box 4 in the present embodiment is implemented in a manner as follows.

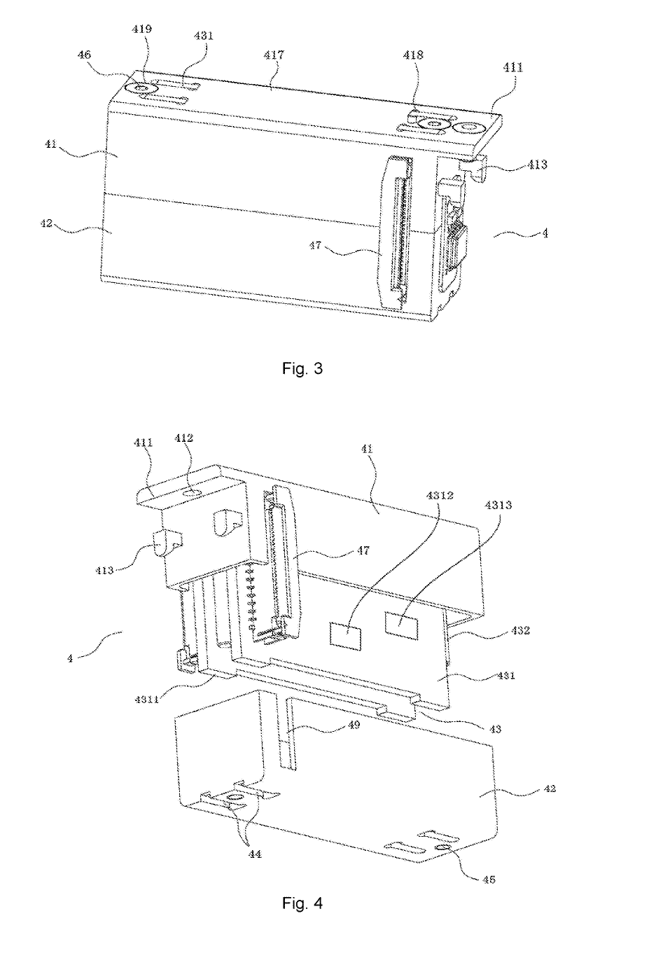

Referring to FIG. 3 and FIG. 4, the control box 4 includes a first housing 41, a second housing 42, a control assembly 43 and a fastener 46. The first housing 41 and the second housing 42 are connected by the fastener 46 so as to be an up-down position. The fastener 46 may be a bolt or pin, and may be fixed by means of a nut, a cotter pin or the like.

Both the first housing 41 and the second housing 42 are disposed to be hollow, so that the interiors of the first housing 41 and the second housing 42 together form an accommodating space. The control assembly 43 is mounted in the accommodating space, and preferably, the control assembly 43 is disposed vertically within the first housing 41 and the second housing 42, so as to make appropriate use of the internal space of the control box 4.

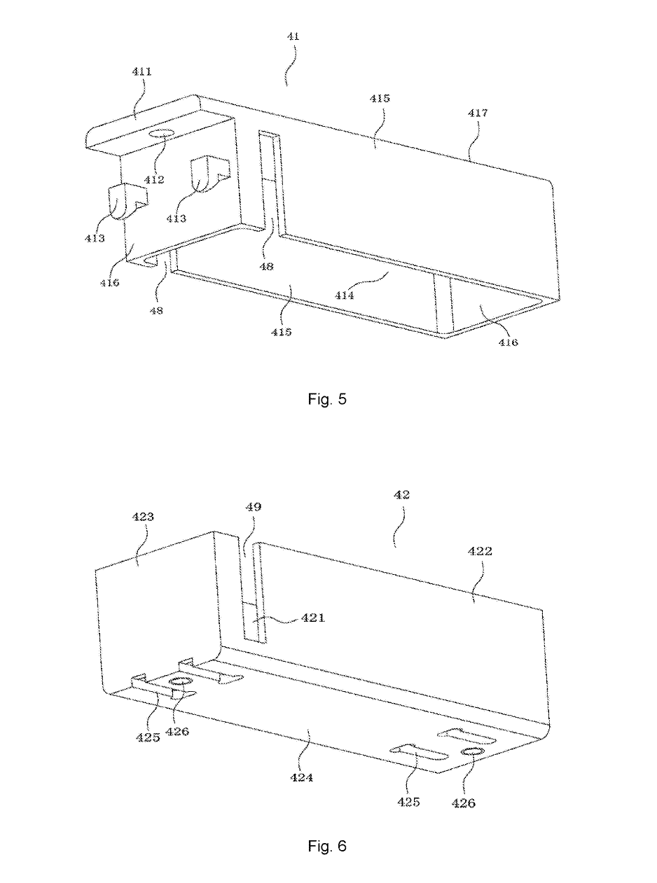

Referring to FIG. 5, in the present embodiment, the first housing 41 is provided with a first accommodating groove 414. Two opposite first side walls 415 are disposed around the first accommodating groove 414, and second side walls 416 are disposed on both sides of the first side walls 415, respectively. An upper surface 417 is provided above the first side walls 415 and the second side walls 416. Both of the first side walls 415 are provided thereon with a first open groove 48, with the two first open grooves 48 disposed at opposite positions. The second side wall 416 close to the first open grooves 48 is provided symmetrically thereon with two claspers 413 each protruding outwardly. The claspers 413 fit with clamping grooves on the gimbal, so as to fix the first housing 41. One end of the upper surface 417 towards the claspers 413 is provided with a connecting plate 411 extending therefrom. A connecting hole 412 is provided at an intermediate position of the connecting plate 411, and the first housing 41 may be fixed to the gimbal by making a fastener such as a bolt pass through the connecting hole 412. The upper surface 417 is provided thereon with first mounting grooves 418 (see FIG. 3) and first mounting holes 419 adjacent to the first mounting grooves 418 (see FIG. 3).

Preferably, a projection position of the connecting hole 412 is located between projection positions of the two claspers 413. In this manner, the two claspers 413 will not interfere with or obstruct the mounting of the fastener such as a bolt, when the first housing 41 is being connected to the gimbal.

Referring to FIG. 6, the second housing 42 is provided with a second accommodating groove 421. The second accommodating groove 421 together with the first accommodating groove 414 form an accommodating space for accommodating the control assembly 43. The second housing 42 is also provided with two opposite third side walls 422 and two opposite fourth side walls 423 surrounding the second accommodating groove 421, where the two fourth side walls 423 are located at both sides of the third side walls 422, respectively. A lower surface 424 is provided under the third side walls 422 and the fourth side walls 423. Both of the third side walls 422 are provided thereon with a second open groove 49 which is disposed opposite to the first open groove 48. The lower surface 424 is provided thereon with second mounting grooves 425 and second mounting holes 426 adjacent to the second mounting grooves 425. The second mounting groove 425 is disposed opposite to the first mounting groove 418, the second mounting hole 426 is disposed opposite to the first mounting hole 419, and the fastener 46 passes through the first mounting hole 419 and the second mounting hole 426 to make the first housing 41 and the second housing 42 connected fixedly.

In the present embodiment, the first mounting groove 418 and the second mounting groove 425 may be collectively referred to as mounting groove 44, and the first mounting hole 419 and the second mounting hole 426 may be collectively referred to as mounting hole 45.

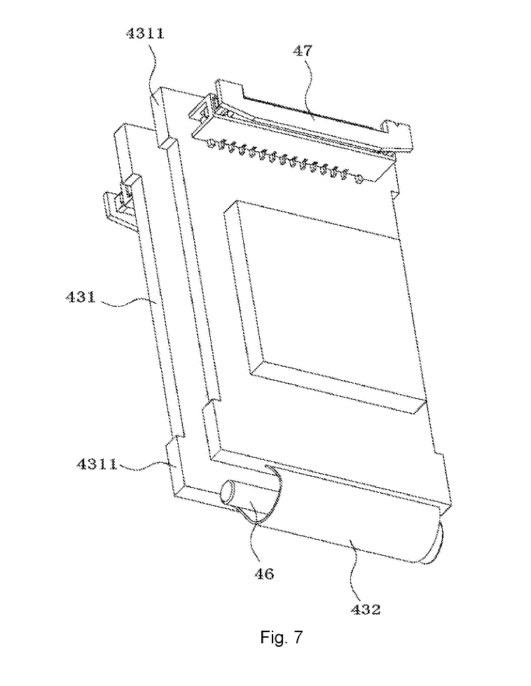

Referring to FIG. 7, the control assembly 43 includes several control boards 431 connected to each of the first housing 41 and the second housing 42. The control boards 431 are provided with drive circuits 4312 (as shown in FIG. 4) and control circuits 4313 (as shown in FIG. 4). The drive circuits 4312 are configured to drive operations of the motors of the gimbal 8, the control circuits 4313 are connected with the drive circuits 4312 and control the drive circuits 4312 to drive the operations of the motors, and the control circuits 4313 are also configured to control other components of the gimbal 8. In the present embodiment, the number of the control boards 431 may be either one or more than one, which may be set in accordance with actual situations.

If there is one control board 431, all of the control circuits 4313 and drive circuits 4312 are integrated on this control board 431. If the number of the control boards 431 is equal to or more than two, the control assembly 43 includes at least two control boards 431 and a flexible connecting plate 432. Two adjacent control boards 431 are electrically connected with each other via the flexible connecting plate 432. In this case, the control assembly 43 may have a part of the control boards 431 provided with the drive circuits 4312 and the other part of the control boards 431 provided with the control circuits 4313; alternatively, it may also have each of the control boards 431 provided with a part of drive circuits 4312 and a part of control circuits 4313; alternatively, it may also have the control circuits 4313 integrated on one control board 431 and the drive circuits 4312 disposed on the remaining control boards 431, which may be set depending on specific needs. In the present embodiment, there are two control boards, with one control board 431 provided with the drive circuits 4312, and the other control board 431 provided with the control circuits 4313.

The control board 431 is provided thereon with several inserts 4311. Each of the inserts 4311 corresponds to respective first mounting groove 418 or respective second mounting groove 425. The control board 431 is connected to the first housing 41 and the second housing 42 by the inserts 4311, specifically, the inserts 4311 are inserted into the first mounting grooves 418 of the first housing 41 and the second mounting grooves 425 of the second housing 42 so as to make the control board 431 connected to each of the first housing 41 and the second housing 42.

Preferably, in the present embodiment, each control board 431 may be provided with four inserts 4311, with the four inserts disposed pairwise on the upper and lower sides of the control board 431 in a symmetrical way; alternatively, each control board 431 may also be provided with two inserts 4311, with the two inserts disposed diagonally on the upper and lower sides of the control board 431. In the present embodiment, it is preferable that each control board 431 is provided with four inserts 4311 and the control board 431 is set to have a rectangular structure, with the inserts 4311 disposed pairwise at ends of two long sides of the control board 431 in a symmetrical way, i.e., located at four corners on the two long sides of the control board 431. Certainly, the control board 431 of the present embodiment may also be circular or of other shapes, and the inserts 4311 may be disposed symmetrically on the upper and lower sides of the control board 431 of such shape.

Since it is preferable in the present embodiment that there is provided with two control boards 431 and each of the control boards 431 is provided with four inserts 4311, the numbers of the first mounting grooves 418 and the second mounting grooves 425 in the present embodiment each is accordingly set to be four, and the first mounting hole 419 of the first housing 41 is disposed between two first mounting grooves 418 in the width direction of the first housing 41, and the second mounting hole 426 of the second housing 42 is disposed between two second mounting grooves 425 in the width direction of the second housing 42.

Referring to FIG. 7, if the number of the control boards 431 is not less than two, the control boards 431 are laminated in row in a layered manner. The control boards 431 located at two end sides are provided thereon with connection terminals 47, respectively. The connection terminal 47 partially passes through an elongated hole formed by the first open groove 48 and the second open groove 49, and is partially located outside the first housing 41 and the second housing 42 (see FIG. 3 or FIG. 4), for connecting components such as the motors of the gimbal 8.

Referring to FIG. 1 or FIG. 2 again, the control box 4 is mounted on the first connecting shaft arm 5 of the gimbal 8. The first connecting shaft arm 5 is provided thereon with a screwed hole (not shown) and clamping grooves (not shown). The connecting plate 411 of the first housing 41 may be connected by making a bolt passing through the connecting hole 412 and the screwed hole of the first connecting shaft arm 5, and the claspers 413 fit with the clamping grooves of the first connecting shaft arm 5. Certainly, the control box 4 in the present embodiment is not limited to being mounted on the first connecting shaft arm 5, it may also be mounted at other positions of the gimbal (for example, the control box 4 may be connected with the yaw axis motor 1, the second connecting shaft arm 6, the rolling axis motor 2 or the pitching axis motor 3). In the present embodiment, the gimbal is provided with three motors (i.e., the yaw axis motor 1, the rolling axis motor 2 and the pitching axis motor 3 described above), and the three motors and other components of the gimbal 8 can be driven and controlled by the drive circuits 4312 and control circuits 4313 provided on the two control boards 431 within the control box 4, thereby effectively solving the problem of too complicated assembly operation existing in the case where each of the motors is provided with a driver and a controller, and simplifying the assembly process accordingly.

The present embodiment further provides an aircraft (not shown), which may be an unmanned aircraft or an aircraft of other types, and has a gimbal which is the gimbal 8 described above. The yaw axis motor rotor (not shown) of the yaw axis motor 1 of the gimbal 8 is connected with the aircraft by a connection platform (not shown).

It will be apparent that the above embodiments of the present disclosure are intended merely to clearly illustrate the examples given in the present disclosure, but not intended to limit the embodiments of the present disclosure. It is to be understood by those skilled in the art that variations or modifications in other different forms may be made on the basis of the above description. It is neither necessary nor possible to exhaust all the embodiments herein. Any modifications, equivalent substitutions, and improvements made without departing from the spirit and principles of the disclosure are intended to be embraced within the scope of the claims of the disclosure.

1. A gimbal, comprising a yaw axis motor, a rolling axis motor, a pitching axis motor and a control box, the yaw axis motor being connected with the rolling axis motor via a first connecting shaft arm, and the rolling axis motor being connected with the pitching axis motor via a second connecting shaft arm, wherein the control box is located below the yaw axis motor.

2. The gimbal according to claim 1, wherein the control box is connected with the yaw axis motor, the first connecting shaft arm, the second connecting shaft arm, the rolling axis motor, or the pitching axis motor.

3. The gimbal according to claim 1, wherein the rolling axis motor is located below the yaw axis motor, the control box is located behind the rolling axis motor, and the control box and the rolling axis motor are fixedly disposed on both sides of the first connecting shaft arm, respectively.

4. The gimbal according to claim 3, wherein the control box is located on one side of the first connecting shaft arm, and the rolling axis motor, the second connecting shaft arm and the pitching axis motor are located on the other side of the first connecting shaft arm, opposite to the control box.

5. The gimbal according to claim 3, wherein the first connecting shaft arm comprises a first connecting section and a second connecting section disposed perpendicular to each other, the first connecting section is provided thereon with a first receiving seat protruding, the second connecting section is provided thereon with a second receiving seat protruding, the yaw axis motor is received in the first receiving seat, and the rolling axis motor is received in the second receiving seat.

6. The gimbal according to claim 5, wherein the second connecting shaft arm comprises a third connecting section and a fourth connecting section disposed perpendicular to each other, the third connecting section is provided thereon with a third receiving seat protruding, the fourth connecting section is provided thereon with a fourth receiving seat protruding, the rolling axis motor is received in the third receiving seat and the pitching axis motor is received in the fourth receiving seat.

7. The gimbal according to claim 1, wherein the rolling axis motor is located below the yaw axis motor, the control box is located in front of the rolling axis motor, and the control box is fixed to the rolling axis motor or the second connecting shaft arm.

8. The gimbal according to claim 1, wherein the pitching axis motor is located below the yaw axis motor, and the control box is fixedly disposed on one side of the pitching axis motor.

9. The gimbal according to claim 1, wherein the control box is fixedly disposed on the yaw axis motor.

10. The gimbal according to claim 1, wherein the control box is of a rectangular structure.

11. The gimbal according to claim 1, wherein the control box comprises a first housing and a second housing connected with each other and disposed opposite to each other, a control assembly is mounted within the first housing and the second housing, the control assembly comprises one or more control boards connected to each of the first housing and the second housing, and the one or more control boards are provided thereon with drive circuits and control circuits.

12. The gimbal according to claim 11, wherein the number of the control boards is not less than two, and the control assembly further includes a flexible connecting plate by which adjacent two of the control boards are electrically connected with each other.

13. The gimbal according to claim 12, wherein each of the control boards is provided thereon with a plurality of inserts, and is connected with the first housing and the second housing by the inserts.

14. The gimbal according to claim 11, wherein the number of the control boards is not less than two, the control boards are laminated in row, and the control boards located at two end sides are provided thereon with connection terminals, respectively, with the connection terminals disposed to partially pass through the first housing and the second housing.

15. The gimbal according to claim 11, wherein the number of the control boards is not less than two, with a part of the control boards provided thereon with the control circuits, and the other part of the control boards provided thereon with the drive circuits connected with the control circuits.

16. The gimbal according to claim 13, wherein the first housing and the second housing are hollow, and the first housing and the second housing each are provided thereon with a plurality of mounting grooves, and the inserts pass through the mounting grooves to make the control boards connected with each of the first housing and the second housing.

17. The gimbal according to claim 14, wherein a first open groove is provided in a side wall of the first housing, a second open groove opposite to the first open groove is provided in a side wall of the second housing, and the connection terminal partially passes through the first open groove and the second open groove and is partially located outside the first housing and the second housing.

18. The gimbal according to claim 11, wherein each of the first housing and the second housing is provided with a mounting hole, the mounting hole in the first housing is disposed at a position opposite to that of the mounting hole in the second housing, and a fastener passes through the mounting holes of both the first housing and the second housing to make the first housing and the second housing connected with each other.

19. The gimbal according to claim 11, wherein one end of the first housing is provided with a connecting plate extending therefrom, and the connecting plate is provided thereon with a connecting hole.

20. The gimbal according to claim 19, wherein a clasper is provided on a side wall of the first housing, with the clasper located below the connecting plate.

21. An aircraft, comprising a gimbal according to claim 1.
